(19) United States
(12) Patent Application Publication
(10) Pub. No.: US 2026/0073070 A1
(43) Pub. Date: Mar. 12, 2026

(54) METHOD AS WELL AS CONFIGURATION PROGRAM FOR CONFIGURING A USER DEVICE AND SAME COMPRISING A SYSTEM PATCHING DATASET FOR A SECURE ELEMENT

(71) Applicant: Glesecke+Devrient Mobile Security Germany GmbH, Munchen (DE)

(72) Inventors: David Patino, El Prat de Llobregat (ES); Maria Teresa Fernandez, El Prat de Llobregat (ES); Clara Gifre, El Prat de Llobregat (ES); Pablo Daniel Gomez Sol, El Prat de Llobregat (ES); Miguel Inguanzo, El Prat de Llobregat (ES); Maria Rivera, El Prat de Llobregat (ES); Jose Antonio Garrido, El Prat de Llobregat (ES); Federico Ruau, El Prat de Llobregat (ES); Joan Francesc Muntaner, El Prat de Llobregat (ES)

(73) Assignee: Giesecke+Devrient Mobile Security Germany GmbH, Munchen (DE)

(21) Appl. No.: 19/326,648

(22) Filed: Sep. 11, 2025

Related U.S. Application Data
(60) Provisional application No. 63/694,067, filed on Sep. 12, 2024.

(51) Int. Cl. G06F 21/62; G06F 21/10

(52) U.S. Cl. CPC G06F 21/6227; G06F 21/1012

(57) ABSTRACT

Methods and systems are provided for configuring a secure element. A method includes steps of providing a secure element with an operating system dataset, the operating system dataset comprising a previous version of at least one executable data subset; installing an application process on the operating system dataset providing access to an application program interface; sending an update data subset through the application program interface to the secure element comprising at least a part of a following version of the at least one executable data subset defining a later version of the operating system dataset; and providing a system patching dataset for managing an installation of the update data subset when implementing the at least a part of the following version of the at least one executable data subset on the secure element such that the later version of the operating system dataset can at least partly be executed.

### CROSS REFERENCE TO RELATED APPLICATIONS

This application claims the benefit of U.S. Provisional Application No. 63/694,067 filed on Sep. 12, 2024, which is hereby incorporated by reference in its entirety.

### TECHNICAL FIELD

The present disclosure relates to the field of configuring user devices, for example, smart cards, transaction cards, personal mobile devices or Internet-of-Things (IoT) devices, or alike, for being securely operated by an authorized user, for instance for conducting secure transactions and/or participating in communication networks. In particular, the present disclosure relates to a method of configuring a user device, in particular for secure operation involving a trusted entity, a configuration program for configuring a user device, in particular for secure operation involving a trusted entity, and a user device, in particular for allowing secure operation involving a trusted entity.

### BACKGROUND

User devices, such as smart cards (e.g., so-called java cards), identification cards, transaction cards, personal mobile devices or IoT-devices, are known from the prior art. The user devices are commonly configured to employ electronic subscriber profiles authenticating a user for secure transactions or communicating on telecommunication networks, e.g., mobile networks. Such user devices are typically equipped with an electronic/embedded secure element (SE, eSE), also known as tamper resistant element (TRE), which may take the form of an embedded universal circuit card (UICC), eUICC, iUICC, SIM, eSIM, iSIM, or alike, configured to store one or more of the electronic subscriber profiles that may allow the user devices to connect to one or more mobile networks. A subscriber profile (e.g., an eSIM profile) may be generated by a mobile network operator (MNO) and may be stored, e.g., downloaded to a mobile user device. The subscriber profile may then be installed on a secure element of the user device and used for communication over a corresponding mobile network by the user device.

The secure elements are run by operation systems (OS) containing software and/or firmware for operating the secure elements. Those OS need to be up to date in order to provide full and reliable functionality of the secure elements. An OS Update is especially relevant with the deployment of embedded Secure Elements (eSE) in the form of cUICC or alike. As opposite of traditional pluggable SIMs that can be inserted and removed, eSEs are soldered into user devices, making it very difficult (or costly) to replace them during the life cycle of the user devices.

Consequently, there is a need for so-called firmware-upgrades and/or updates that allow to modify the content of the eSE in the event that it has to be kept up to date and/or a technical issue has to be fixed. For example, one possible reason for that firmware has to be kept up to date is if a related standard, such as a GSMA specification, relating to the user device changes or is being newly implemented. In any case, such updates can be carried out with the help of an Open Firmware Loader (OFL), or alike, which is specifically designed software component in charge of firmware upgrades including OS updates in the secure element. The need to be able to update the software for certain SE/TRE has generated many different approaches worldwide. In some solutions, there is a separate entity (ITL—Image Trusted Loader, OFL, Update Agent) which is kept in charge in the SE/TRE while the full OS, or only part of it, is changed. The states of the SE/TRE are then not really defined according to any global entity.

WO 2023 006247 A1, for example, relates to a method and an apparatus for updating software loaded on a secure element, SE, which SE comprises an update agent handler, and an update agent. In a first step, a request to back-up a current version of software loaded on the SE is received at the SE. The request is preferably sent from a device, external to the SE. Upon receiving the backup request, the SE performs a secure backup of the current software version, and returns the software backup to the device, to be stored thereon. In a further step, the SE performs an update process of the current software version, to obtain an updated software version. If the update process fails, a rollback is performed at the SE to restore the software backup as a new current software version on the SE.

EP 4 120 066 A1 relates a method and a device for upgrading an Executable Load File (ELF), having dependencies, on a Secure Element, SE. The method comprises in a first step receiving a request for upgrading an ELF, the request comprising a first identifier, identifying a first ELF version loaded on the SE, a second identifier, identifying a second ELF version loaded on the SE, and an upgrade option. Upon receiving the request, dependencies of the first ELF version from other ELFs loaded or stored on the SE are determined. Subsequently, if dependencies have been determined, it is checked whether the upgrade request is allowed. If the update request is allowed, an upgrade session is started, and the first ELF version is replaced with the second ELF version. The dependencies of the first ELF version are then linked to the second ELF version.

WO 2022 161946 A2 describes a system comprising at least one secure server computer configured to execute a predefined code sequence in a transactional fashion on input data to produce output data, and configured to provide a signed response packet that proves that the code sequence (unmodified since its installation) was executed on the input data and resulted in the output data. In an embodiment, the code and its secure isolated execution environment on the secure server computer system may be transactional. In an embodiment, the customer critical code and the secure isolated execution environment may be instantiated each time the application (executing on another computer) transmits a request with input data. Upon completion of the transaction, the secure server computer may remove the customer critical code and the secure execution environment from system memory, deleting its context and any other data related to the environment.

U.S. Pat. No. 10,599,472 B2 relates to a software updating method. A target file is divided into segments, where some segments are updated by patching, while other segments are updated by archiving. The segmentation of the update allows very large files such as DYLD shared caches to be patched in-place, i.e., by using free space available within the file to perform patching rather than requiring enough free space on disk to store both the new version and the old version of the file. The segmentation of the update also allows each segment to be updated individually by the most optimal update method (copy, patch, or archive) so that the size of the update file can be minimized.

Methods for providing and upgrading secure elements of user devices, including OS updates, as described above, may not fully satisfy all requirements regarding their deployability and availability on the one hand, as well as functional safety and security on the other hand. For example, it is desirable that both, the OS, and the secure elements have the same origin and preferably same state of development in order to ensure functional safety and security. However, due to deployability and availability restrictions, it may not be always assured that the OS, as well as the secure elements have the same origin, corresponding versions, or meet certain future requirements, especially if an implementation of a new specification or standard for operating the user devices is expected to be issued during lifetime of the user device and/or respective secure element. This may limit the functionality, especially a spectrum of (future) capabilities, of the user device, may compromise functional safety and security when operating user devices, or may even lead to that the devices cannot be configured properly, keeping in mind that not only the OS but also related data structures can be affected by updating procedures.

### SUMMARY

It may be seen as an object to improve the interaction between the secure elements and their OS. In particular, it may thus be seen as an object to provide a way to handle secure elements and their OS in a way that a future proof functional spectrum, safety and security may be assured, while not compromising deployability, availability, and/or data integrity. These objects are at least partly achieved by the subject-matter of the independent claims.

According to an aspect, a method of configuring a secure element, in particular for secure operation involving a trusted entity, is provided, the method includes the steps of providing a secure element, such as an eUICC, for a user device, with an operating system dataset for operating the secure element, the operating system dataset comprising a previous version of at least one executable data subset which may be configured to access at least one data object having a predefined data format; installing an application process on the operating system dataset providing access to an application program interface; sending an update data subset through the application program interface to the secure element including at least a part of a following version of the at least one executable data subset defining a later version of the operating system dataset; and providing a system patching dataset for managing an installation of the update data subset when implementing the at least a part of the following version of the at least one executable data subset on the secure element such that the later version of the operating system dataset can at least partly be executed.

According to an aspect, a configuration program for configuring a secure element, in particular for secure operation involving a trusted entity, is provided, wherein the configuration program includes instructions which, when the configuration program is executed by at least one of a server device, a user device and a secure element, cause at least one of a server device, a user device, and a secure element to carry out the steps of providing a secure element, such as an cUICC, for a user device, with an operating system dataset for operating the secure element, the operating system dataset including a previous version of at least one executable data subset which may be configured to access at least one data object having a predefined data format; installing an application process on the operating system dataset providing access to an application program interface; sending an update data subset through the application program interface to the secure element including at least a part of a following version of the at least one executable data subset defining a later version of the operating system dataset which may be configured to access the at least one data object; and providing a system patching dataset for managing an installation of the update data subset when implementing the following version of the at least one executable data subset on the secure element such that the later version of the operating system dataset can be executed.

According to an aspect, a secure element, such as an eUICC, for a user device, in particular configured for allowing secure operation involving a trusted entity, is provided, with an operating system dataset for operating the secure element, the operating system dataset including a previous version of at least one executable data subset which may be configured to access at least one data object having a predefined data format; with an application process installed on the operating system dataset providing access to an application program interface; wherein the secure element is configured to receive an update data subset through the application program interface including at least a part of a following version of the at least one executable data subset defining a later version of the operating system dataset; and use a system patching dataset for managing an installation of the update data subset when implementing the following version of the at least one executable data subset on the secure element such that the later version of the operating system dataset can be executed.

According to an aspect, a method of configuring a user device, in particular for secure operation involving a trusted entity, is provided, the method including the steps of providing a secure element of the user device, such as an eUICC, with an operating system dataset for operating the secure element, the operating system dataset including a previous version of at least one executable data subset defining a former version of an application process configured to access at least one data object having a predefined data format; sending an update data subset to the secure element including at least a part of a following version of the at least one executable data subset defining a later version of the application process configured to access the at least one data object; and providing a system patching dataset for managing an installation of the update data subset when implementing the at least a part of the following version of the at least one executable data subset on the secure element such that the later version of the application process can at least partly be executed.

According to an aspect, a configuration program for configuring a user device, in particular for secure operation involving a trusted entity, is provided, wherein the configuration program includes instructions which, when the configuration program is executed by at least one of a server device, a user device and a secure element, cause at least one of a server device (4), a user device, and a secure element to carry out the steps of providing a secure element of the user device, such as an eUICC, with an operating system dataset for operating the secure element, the operating system dataset including a previous version of at least one executable data subset defining a former version of an application process configured to access at least one data object having a predefined data format; sending an update data subset to the secure element including at least a part of a following version of the at least one executable data subset defining a later version of the application process configured to access the at least one data object; and
providing a system patching dataset for managing an installation of the update data subset when implementing the following version of the at least one executable data subset on the secure element such that the later version of the application process can be executed.

According to an aspect, a user device is provided, in particular configured for allowing secure operation involving a trusted entity, wherein the user device is provided with a secure element, such as an eUICC, with an operating system dataset for operating the secure element, the operating system dataset including a previous version of at least one executable data subset defining a former version of an application process configured to access at least one data object having a predefined data format; and is configured to receive an update data subset with the secure element including at least a part of a following version of the at least one executable data subset defining a later version of the application process configured to access the at least one data object; and use a system patching dataset for managing an installation of the update data subset when implementing the following version of the at least one executable data subset on the secure element such that the later version of the application process can be executed.

A computer-readable data carrier may be provided having stored thereon a configuration program and/or a system patching dataset. The user device may include a configuration program, a system patching dataset according and/or a computer-readable data carrier. A server device, in particular a security server providing a secure location for allowing secure operation of user devices involving a trusted entity, maybe provided, wherein the server device is configured to carry out a corresponding method, includes a corresponding configuration program, a corresponding system patching dataset and/or a corresponding computer-readable data carrier.

The secure element may be understood as a tamper resistant element (TRE). The at least one update data subset may be provided as a data image. The update data subset may include the following version at least one executable data subset defining a version of the operating system dataset, the application process, and/or any data subset thereof configured to access the at least one data object. The application process may include and/or involve program application and/or application programming interface (API). A complete operating system update dataset including the at least one update data subset may be provided for replacing the previously installed operating system dataset. Data objects can be and/or include any kind of data element or constructs of data, including, but not limited to data gateways, data accesses, data streams, data blocks, functional elements, code segments, data files, or alike, such as source code, machine code, code subsets, function parameters, variables, values, objects, pointers, memory regions, memory addresses, address spaces, binaries, sounds, images, videos, text, emails, documents, images, folders, keys, certificates or any part, combination, group thereof and/or other information related thereto, critical or not, which can take a desired or required form or shape needed by the operating system dataset, related datasets, executable data subset and/or update data subset provided as a part thereof and/or related thereto to enable at least one specific functionality for which it has been conceived and/or implemented, etc. The expression “dataset” can be understood as any kind of data composition, such as a file, including source code, object code, or binaries, which may have or fulfil a certain technical function.

The proposed solution allows for providing updated operating system setups and/or application data subsets in the form of patches without the need to erase previous versions of operating system datasets and/or data objects, such as personal data stored on the user device and/or the secure element by the user. For example, the solution can be implemented by providing the operating system dataset in the form of an eOS along with application data subsets. Such an COS and/or respective application can be configured (i.e., in factory) with a minimum eSIM configuration necessary for fielding the user device. The eOS can be provided by a respective trusted entity (including respective identification codes and keys, such as activation keys and public keys) to perform an activation of functions and/or profiles later on in the field, where the eOS can still be updated as required and/or desired without the need to alter or erase certain data objects for or during the updating process. The system patching dataset may be provided as part of an installation program dataset, a “Java-App”, and/or can be implemented in native OS code configured for operating the secure element.

The proposed solution has the advantage over the prior art, that the operating system dataset can be delivered along with application data subsets to any manufacturing facility, including OEM/ODM vendor facilities, and fabrication facilities of the secure element, regardless of a change to standards and/or specifications relating to the user device between the delivery and a later point of the time of deployment of user devices and/or the secure elements to customers. At first, the operating system dataset and/or application data subsets allow for configuring the user device and/or the secure element in a way that it can be deployed to customers, enabling them to adopt upcoming or following standards and/or specifications along with a respective functional spectrum, safety, and security by means of the operating system dataset along with application data subsets. Later on, update data subsets can be installed without the need to reset the user device and/or secure element back to default settings.

Hence, the proposed solution allows for a configuration and update of the secure element “Over-The-Air”, removing the necessity of physically replace the secure element for updates and/or upgrades. The data to be updated can be kept minimal as a preferably large amount of data for default operation of the user device can be implemented in the operating system dataset which may provide an initial operating system and respective application processes for the secure element. Thereby, secure elements and their OS and/or application programs can be handled in a way that a future-proof functional spectrum, safety and security may be assured, while not compromising their deployability and availability.

Further developments can be derived from the dependent claims and from the following description. Features described with reference to a user device, secure element, server device and components thereof may be implemented as method steps, or vice versa. Therefore, the description provided in the context of the user device, secure element, server device and their components apply in an analogous manner also to respective methods. In particular, features and functions of the user device, secure element, server device and their components may be implemented as method steps which in turn may be implemented as respective device features or functions.

According to a possible embodiment of the method, at least a when the later version of the application process can be executed, the system patching dataset checks whether the predefined data format of the at least one data object matches a required data format defined by the later version of the application process before accessing the at least one data object with the later version of the application process. If an update is at hand, existing data should be kept. For example, a data structure including several fields with respective formats and/or definitions (Boolean, Int, float, etc.) can be provided for checking the data formats. If old and new structures are compatible with each other, no actions need to be taken to be taken. Otherwise, the system patching dataset can relocate data values and the reinstate them in new formats. E.g., if an old field was float and should be reduced to int, a piece of code of the system patching dataset can act as a translator giving a specific transformation pattern, possibly involving truncation. This improves flexibility in handling secure elements and their OS and/or application programs in a way that a future-proof functional spectrum, safety and security may be assured, while not compromising their deployability and availability.

According to a possible embodiment of the method, the method further includes the step of updating the predefined data format to the required data format if the predefined data format does not match the required data format. The data formats may correspond to respective classes, also called data instances, such as float, integer, short, etc. The at least one data object can be left untouched when installing the following version of the at least one executable data subset. For example, the data contents of the original data object can be encapsulated during the update process and/or afterwards before first accessing the data object. This further helps in avoiding unwanted data changes and inconsistencies. The step of checking can be carried out upon a first time of handling the at least one data object with the later version of the application process. For example, whenever a data object is supposed to be used, then the data object is updated at the time of first usage. A respective format or instance of the data object can be checked before accessing the respective data object. The predefined data format can be adjusted to the required data format if the predefined data format does not match the required data format. In order to create a new data object, and underlying previous data object can be copied and morphed into the new object. For example, an old data array of a size “3” would be copied into a new data array of a size “4”. This further helps in saving computing resources and to avoid unwanted data changes, as well as to improve flexibility in handling secure elements and their OS and/or application programs in a way that a future-proof functional spectrum, safety and security may be assured, while not compromising their deployability and availability.

According to a possible embodiment of the method, and/or user device, the at least one data object is allocated to a certain memory region and the method further includes the step of reallocating the at least one data object to a different memory region if the predefined data format does not match the required data format. The method may further include the step of discarding the at least one data object in the predefined data format if the predefined data format does not match the required data format and/or data class. For example, after copying an old data array of a size “3” into a new data array of a size “4”, the old data array can be discarded. This can help to free memory space after an update has been performed. A defragmentation mechanism can solve efficient use of the memory allocations. This can again help in saving computing resources, in particular memory space required, and avoiding unwarranted data changes.

According to a possible embodiment of the method, and/or user device, the system patching dataset is configured to patch the operating system dataset with the update data subset. By patching the operating system dataset, specific parts and special functions of the operating system dataset may be altered as desired or required at a certain point of time. This further helps in saving computing resources and to avoid unwanted data changes, as well as to improve flexibility in handling secure elements and their OS and/or application programs in a way that a future-proof functional spectrum, safety and security may be assured, while not compromising their deployability and availability.

According to a possible embodiment of the method, and/or user device, the system patching dataset is configured to jump to specific parts or sections of the operating system dataset addressed by the update data subset. The specific part or sections of the operating system dataset may be executed in a certain sequence defined in the operating system dataset and/or the system patching dataset or any update or patch thereof. In other words, respective code may be required to jump to specific places that may change due to an update. The system patching dataset should take care of any inconsistencies regarding jumps, symbols, pointers, etc., for example, by focusing on jump points. Thereby, the system patching dataset can make sure that the updated code works. Thereby, a secure updating procedure of data formats of the data objects can be assured.

According to a possible embodiment of the method, and/or user device, the system patching dataset is at least in part provided as a one-time code (OTC) configured to be discarded after a successful installation process. OTC can be embodied as executable (native) code and/or java card. Native is preferred because it is most versatile and accessible (Java-Code is high level). OTC can provide diagnostic information or allow the execution of certain routines that are only needed provisionally. The system patching dataset can be implemented as a special manager/arbiter which may having its own internal state machine, but conditions can be dispersed. A corresponding OTC-manager can be the entity requesting and/or notifying about the process, maybe informing an installation program dataset, such as an ITL and/or the OS, but can also perform actions by itself. This further helps in providing a secure updating procedure. This further helps in providing a secure updating procedure.

According to a possible embodiment of the method, and/or user device, the system patching dataset enables implementation of at least two update steps configured as roll back options for the installation process. The system patching dataset can provide be configured as an update agent enabling rollbacks to defined installation points of the installation process. Incremental updates can be performed an enable to return to defined fallback points/intermediate states. The intermediate states should be functional, so that update can be strategically implemented. Otherwise, a very limited functional state would be at hand, possibly loosing connectivity and only the ITL might stay functional. This further helps in providing a secure updating procedure.

According to a possible embodiment of the method, and/or user device, the system patching dataset is configured to be executed in a security domain managed by a secure entity. For example, an applet running in a Security Domain can be managed by a secure entity. Such an application may also be used for pluggable SE/TRE, such as pluggable SIMs. The present solution that enables patching of the OS of pluggable SIMs. Respective application can have access to an API controlled by a trusted entity. Such an application was previously not conceived for pluggable SIMs because they are functionally even more constrained than other embedded SE/TRE.

According to a possible embodiment of the method, and/or user device, the system patching dataset is configured to defer or at least delay the installation process after receiving the update data subset. The patch might not be applied upon the time of receipt. The system patching dataset can be in charge in deciding upon the time of update. Respective conditions for deciding whether to update or not may depend on whether there is a device is running in a low power mode, power supply mode, connectivity mode, and/or a decision by user, allocation or respective time slots, etc., is at hand. This further helps in providing a secure updating procedure.

According to a possible embodiment of the configuration program, the configuration program includes or is included of the system patching dataset for updating at least a part of an operating system dataset of a secure element of a user device, such as an eUICC. The system patching dataset may include a at least parts of a corresponding configuration program. Alternatively, or additionally, the system patching dataset may be provided as a part of an installation program dataset, such as an ITL. This further helps in saving computing resources and to avoid unwanted data changes, as well as to improve flexibility in handling secure elements and their OS and/or application programs in a way that a future-proof functional spectrum, safety and security may be assured, while not compromising their deployability and availability.

### BRIEF DESCRIPTION OF THE DRAWINGS

FIG. 1 is a schematic illustration of a configuration system for carrying out a method according to the present disclosure.

FIG. 2 shows a schematic illustration of memory allocations during and after an update procedure.

FIG. 3 shows a schematic illustration of alternative memory allocations.

FIG. 4 shows further schematic steps of a method for updating the secure element by means of the installation program dataset and/or system patching dataset.

FIG. 5 is a schematic illustration of how an off-card entity can communicate with an application process running on a secure element.

FIG. 6 is another schematic illustration of how an off-card entity can communicate with an application process running on a secure element.

### DETAILED DESCRIPTION OF EMBODIMENTS

The following detailed description is merely exemplary in nature and is not intended to limit the invention and uses of the invention. Furthermore, there is no intention to be bound by any theory presented in the preceding background or the following detailed description. The representations and illustrations in the drawings are schematic and not to scale. Like numerals denote like elements. A greater understanding of the described subject matter may be obtained through a review of the illustrations together with a review of the detailed description that follows.

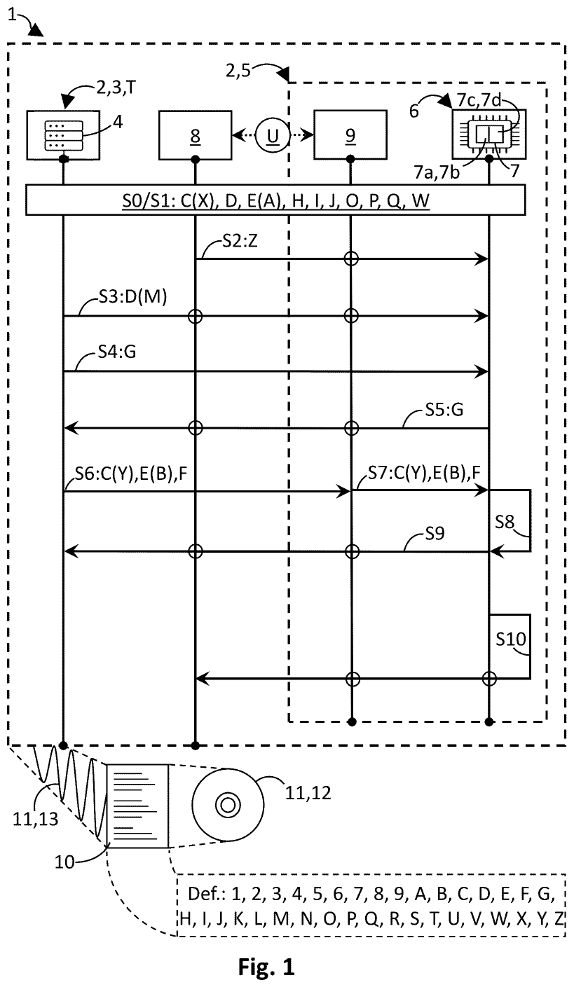

FIG. 1 shows a schematic illustration of a configuration system 1 comprising a computing device 2, for instance, in the form of a server device 3 controlled by a trusted entity T, which can include a hardware security module 4 adapted to store, manage and/or provide operating system datasets O for configuring a further computing device 2, for example, in the form of a user device 5 which may be embodied an Internet of Things (IoT) device, such as a multimedia device, camera, speaker, household appliance, measurement device, industrial installation, vehicle, vending machine, or alike, to be associated with a machine entity, and/or as a smart card, an identification card, a transaction card, a personal mobile device, such as a smartphone, smartwatch, etc., to be associated with a personal entity. For example, the server device 3 may be provided in the form of a Server for Subscription Manager Data Preparation+(SM-DP+).

In the present example, the user devices 5 may be adapted for secure operation, transactions and/or communication, e.g., via a telecommunication network (not shown) by means of at least one user profile dataset P to be saved in a respective secure element 6 or tamper resistant element (TRE), such as an UICC, eUICC, iUICC, SIM, eSIM, iSIM, SE, eSE, or alike, provided in the form of a computer chip. The user profile data sets P are generated based on respective personal records contained in data files on the server device 3, in particular, the hardware security module 4 thereof. For storing and managing user profile data sets P on the secure elements 6, an operating system dataset O is installed on the secure element 6, for example, in a secure storage location 7, such as an Issuer Security Domain-Root (ISD-R) provided on the secure element 6. The secure storage location may provide different memory regions, such as at least one first memory region 7a and at least one second memory region 7b.

The operating system dataset O comprises an executable data subset E which can be provided as a previous version A and a later version B defining a former version X and a later version Y, respectively, of an application process C configured to access at least one data object D. The executable data subset E can be updated from the previous version A to the later version B by means of an update data subset F. The data object D can have a predefined data format M and the required data format N corresponding to the former version X and the later version Y, respectively, of the application process C.

A management application 8 may be provided which can be configured to allow a user U to communicate with the user device 5, in particular the secure element 6, for example, directly and/or through a communication interface 9 to the user device 5. The management application 8 can be provided in the form of a remote manager, such as an eSIM IoT remote manager (eIM) which may be securely identified by means of an application identifier and/or authenticated by means of an authentication certificate. The communication interface 9 may be provided in the form of a logical end-to-end interface (ESep) enabling secure communications between the management application 8 and the secure element 6, which can be used to transfer data packages, such as cUICC Packages, for instance to carry out Profile State Management and eIM configuration tasks by means of the eIM. For example, the communication interface 9 may be provided as a part of a local management application, such as a IoT Profile Assistant (IPA), which may take the form of an IoT Profile Assistant (IPAd) provided to the user device 5, and/or an IoT Profile Assistant provided (IPAe) arranged in the secure element 6. Alternatively, or additionally, the management application 8 and/or communication interface 9 may be provided as a local profile assistant (LPA) provided to the user device 5 and/or arranged in the secure element 6

Furthermore, the operating system dataset O may comprise an installation program dataset I, a system patching dataset J, a user profile P and/or security credentials H, including application identifiers, authentication certificates and/or security keys. The security credentials H may comprise any kind of credentials defined by e.g., the GSMA, or alike. The security keys may comprise any kind of cryptographic code or key element which may be adapted to interact with the user devices 5, the secure elements 6, and/or the server device 3 of the trusted entity T as an issuer of any part of the operating system dataset O and/or any component thereof. The authentication certificates may be any kind of electronic certificate, for example, that can be issued by the trusted entity T, for authenticating an origin of the user devices 5, the secure elements 6, the secure storage location 7 and/or the operating system dataset O. Transmission lines (not shown) may be provided for handling and/or transferring the operating system dataset O may comprise any kind of wired and/or wireless transmission chains, including the Internet (for transmissions “Over-The-Air”) as well as other physical and/or non-physical data carriers, which can be configured and secured as desired and required by the configuration system 1 and its components.

In any of the embodiments of the configuration system 1 as described herein, in particular the computing devices 2, can be configured to execute a computer program in the form of a configuration program 10. A computer-readable data carrier 11 can have stored thereon the configuration program 10 and may take the form of a computer-readable medium 12 and/or data carrier signal 13. When carrying out the configuration program 10, the security system 1 and any components thereof communicate as specified in the security program 10. Parameters associated with and/or underlying the security system 1, any of the components thereof and/or any steps S carried out thereby, can be defined in and/or by the configuration program 10.

In a first step S1, the server device 3 may provide any of the data components of the configuration system 1, including the operating system dataset O, possibly along with the installation program dataset I, the system patching dataset J, respective diversified data L and/or user profile P associated with the user U, to the secure element 6 of the user device 5, for example through the communication interface 9 to be stored in the secure storage location 7 for deployment to the user U. In a second step S2, the previous version A of the executable data subset E including the former version X of the application process C may be activated, for example, by an activation signal triggered by the user U through the remote management application 8 and/or the communication interface 9, in order to enable the user device 5 to carry out operations according to the former version X. For activating the executable data subset E, the user may use respective security credentials H. In a third step 3, after activation and/or authorization through the security credentials H, the user U and/or server device 3 may transfer, create, and/or alter data objects D to and/or in, respectively, the secure element 6, in particular, in line with the predefined data format M as required by the previous version A of a respective application process C.

In a fourth step S4, a notification signal G may be provided by the server device 3 informing the user U and/or the system patching dataset J, that an update data subset F is available for installation of the secure element 6. Along with the notification signal G, another notification signal G in the form of a data request command for requesting and/or confirming installation of the update data subset F may be made available to be used by the user device 5, for example, in that the user U and that of the system patching dataset J are or is, respectively, allowed to trigger initiation of the update process by respective security credentials H to be checked in the secure element 6. In a fifth step S5, the user U can request installation of the update data subset F. In a sixth step, the update data subset F may be requested by the user U and of the system patching dataset J by sending the notification signal G for the update request to the server device 3.

In a sixth step S6, the update data subset F may be provided, for example, in the form of a patch, from the server device 3 to the user device 5, for example, by download through and/or to the communication interface 9, such that the update dataset subset F and/or a respective patch are or is, respectively, ready to be installed in the secure element 6. The update data subset F comprises the following version B of the at least one executable data subset E defining a later version Y of the application process C. In a seventh step S7, the update may be performed on the secure element 6 with the help of the system patching dataset. The update process can be supervised by the operating system dataset O.

In an eights step S8, the update may be finished, for example, involving a reboot of the secure element 6, which can be initiated after successfully installing and/or patching, for example, after certain increments of the respective process under control of the system patching dataset J. In a ninth step S9, the user U and/or the secure entity T may be informed of whether the update process was successful or not. If the update process was not successful, it may be repeated, for example, starting from the fourth step S4 of notifying the user U of the system patching dataset J. If the update process and/or any increment thereof was successful, then in a tenth step S10, it may be checked whether the predefined data format M of at least one data object D matches are required data format N.

A zeroth step S0 can be associated with a pre-issuance condition W of the user device 5 and/or the secure element 6. The secured state 22, the installed state 23 and/or the locked state 24 can be associated with a post-issuance condition Z of the user device 5 and/or the secure element 6.

The initialized state is typically associated with the pre-issuance condition W since the installation program dataset I is usually provided to the user device 5 and/or the secure element 6 at a factory, for example at any manufacturing facility, including OEM/ODM vendor facilities, and fabrication facilities of the secure element 6, which may involve and/or be administered by the trust entity T and/or the server device 3. Providing the installation program dataset I to the user device 5 and/or the secure element 6 can be regarded as the zeroth step S0 which may take place before first step S1 of providing data to the user device 5 and/or the secure element 6 (see FIG. 1). In the initialized state, the installation program dataset I is loaded into the secure element 6, for example, without being provided with any further data, such as diversified data L.

Consequently, the initialized state may be set and/or assumed until necessary diversified data L, for example, by respective application commands K, such as personalization commands. After fielding the user device 5 and/or the secure element 6, the initialized state should never be assumed again since this would be associated with returning to a pre-issuance condition W which should only be assumed in a protected environment involving the trust entity T. In other words, returning to the initialized state and/or pre-issuance condition W is not an option for performing OS data updates, because after being issued/fielded, for example, by being handed out to the user U, the secure element 6 is actually in an uncertified environment.

For altering any functions, sections asset or segments can of the operation system dataset O installed on the user device 5 and/or the secure element 6, the system patching dataset J can be provided. Additionally, or additionally, an installation program dataset I and/or an installation instance implemented thereby can control the installation process and its progress, for example, by being in charge of the process of installing the operating system dataset O and/or the update data subset F. In the event of a reset, the installation program dataset I and/or installation instance can answer. The installation program dataset I can be provided with all necessary diversified data L.

Installing the update data subset F may only be allowed to be performed by means of the installation program dataset I and/or the system patching dataset J, for example, a secured state supervised by the trust entity T. Hence, the secured state can be considered as being in a hybrid condition between the pre-issuance condition W and the post-issuance condition Z because the operating system dataset O can be and/or is being changed, considering that such changes that are actually being made should not correspond to an operational post-issuance state Z of operating the secure element 6, for example, as provided in a installed state. Furthermore, a so-called MockSIM can be installed and/or activated in the secure element 6 during the secured state 22 in order to prevent a power off from a baseband which may interrupt the installation process.

In the installed state, the installation program dataset I and/or system patching dataset J can be deactivated. An operating instance V implemented by the operating system dataset O can be in charge of any processes running on the secure element 6. In the event of a reset, the operating system dataset O operating instance V can answer. Hence, the installed state can be considered as the normal operating state for the user device 5 and/or the secure element 6 when being operated by the user U in the field, for example by corresponding to application commands K, such as APDU (Application Protocol Data Unit) commands.

The update and/or patching process can be supervised by the system patching dataset J, which can run a respective supervision instance Q. The operating system dataset O can provide a runtime environment that is ready to handle application commands K, for example, in that it may receive, execute and/or respond to APDU commands. The secure element 6 can be provided with certain security credentials H, diversified data L and/or user profile P data. A secured state can be used for normally operating the secure element 6 while containing all security credentials H necessary for full functionality of the secure element 6.

For allowing to securely conduct update processes, for example, by installing the update data subset F, an operating instance V of the operating system dataset O may hand over control to the data update instance R of the system patching dataset J. While the system patching dataset carries out the installation of the update data subset F, a supervision instance Q implemented by the operating system dataset O can query, supervise and/or revise the installation process. Respective information may be provided to the supervision instance Q by the data update instance R. The supervision instance Q may be controlled and/or provided by the operating instance V. Therefore, the operating instance V can be notified of the ongoing installation process of at least one update that a subset F.

When a update data subset F, such as a patch, is loaded into the secure storage location 7, and in case there is a change in the memory structures that allow the comprehension of the data from the secure element 6, part of the system patching dataset J may include a routine to analyze the memory regions 7a, 7b, to identify all the data object D that will potentially be uncomprehensible after the update is performed. The affected data objects can be stored in a different memory region 1a, 7b with the original values (including any extra security measures that were applied to that data, if needed) and the information of the respective memory position in which it was previously stored. Another routine may be implemented in the updated a subset F and can then executed: it may generate new data object D according to the original values and adapting them to the new memory structures that will be updated. The patch/update can then be finished. Once everything is finished and in place, a validation process can be performed by the system patching dataset J. If everything is OK, the provisional code and data are deleted. Otherwise, they are restored to their original values.

For example, the installation program dataset IN/or the system patching dataset J can be is used to download the update data subset F, which can be loaded into a free memory region 7a, 7b. The respective memory 7a, 7b region in which the update data subset F will be provisionally could be selected as a different memory region than the final destination of the update data subset F or respective system patch implemented thereby. The update data subset can then be implemented by a number of copying routines, such as (a.) the code from the “to be updated region” is copied into a provisional memory area 7a, 7b; (b.) it copies the “new code” into the “to be updated” area, performing the required changes in the memory. Once the update is finished, in the next boot integrity checks can performed and if everything is OK, the provisionally stored update data subset F can be deleted together with any part of respective code that were provisionally stored. In case there was any issue, the routine would restore the memory to its previous state by copying the code again in its original memory area.

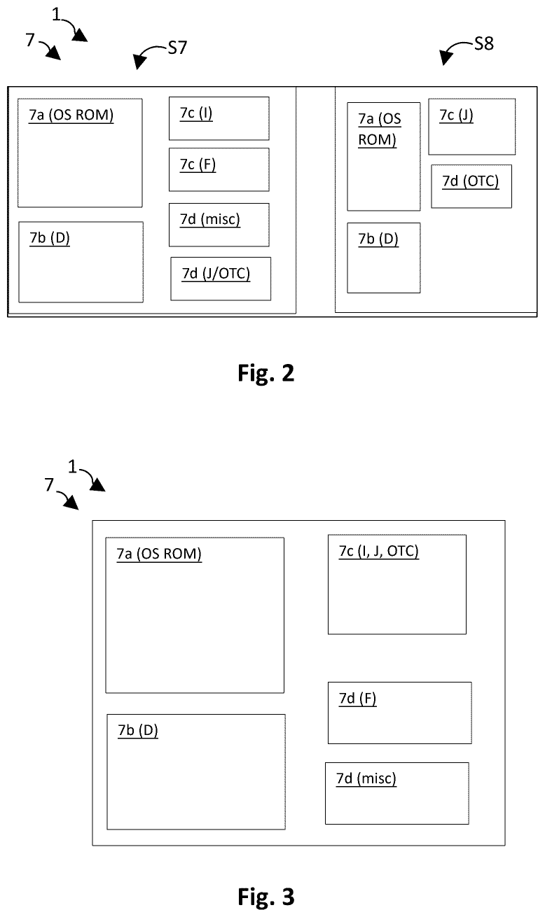

FIG. 2 shows a schematic illustration of memory allocations during (e.g., S7) and after an update procedure (e.g., S8). One Time Code OTC can provide diagnostic information or allow the execution of certain routines that are only needed provisionally. It can also help in identifying potential issues or bugs. Once used, this one-time code OTC could be removed. Therefore, the system patching dataset J can be implemented as a One Time Code Manager (OTCM) that would manage such kind of code, accepting or rejecting it and, in case of accepting it, making sure it is removed after usage. The system patching dataset J can either be independent from the rest of the software in the secure element 6 or be part of another one (for example, an update agent, such as the installation program dataset I.

For respective updating processes, (1.) The petition to load a new piece of OTC would be received by the system patching dataset J. (2.) The system patching dataset J would generate some session data to manage the petition, regarding security of the OTC, which entity is being targeted, in case more than one entity is available in the secure element 6, the conditions that need to be fulfilled to load it and the conditions that will be needed to use it and finally remove it (for example, if there needs to be some kind of communication with an off-card entity or not). (3.) If the conditions are fulfilled, the OTC would be loaded. The system patching dataset J might or might not be the one in charge of actually receiving and writing the code, it could be done by a separate entity which receives the necessary information for t its part of the process from the system patching dataset J. (4.) Once loaded, when the conditions for usage according to the session data are met, the OTC will be executed.

Although it is referred to as One Time Code, the conditions could potentially include a certain number of executions to happen. Once the end conditions are met, the system patching dataset J would remove (or trigger the order to remove) the code. As aforementioned, the entity responsible for that process might be separate from the system patching dataset J. The OTC to be loaded could include solutions like:
A heap analyzer
A solution to fix some corrupted memory
A piece of code to manage the data compatibility of an OS Update solution
Memory dump module

FIG. 3 shows a schematic illustration of alternative memory allocations. For example, memory error 7a is dedicated for the operating system dataset O. Memory area 7b can be dedicated to certain data objects D. The installation program dataset I, system patching dataset J and/or one-time code OTC can be loaded in a dedicated memory area 7c. Memory area 7d can hold the update data subset F. Furthermore, memory area 7d can hold miscellaneous data (misc).

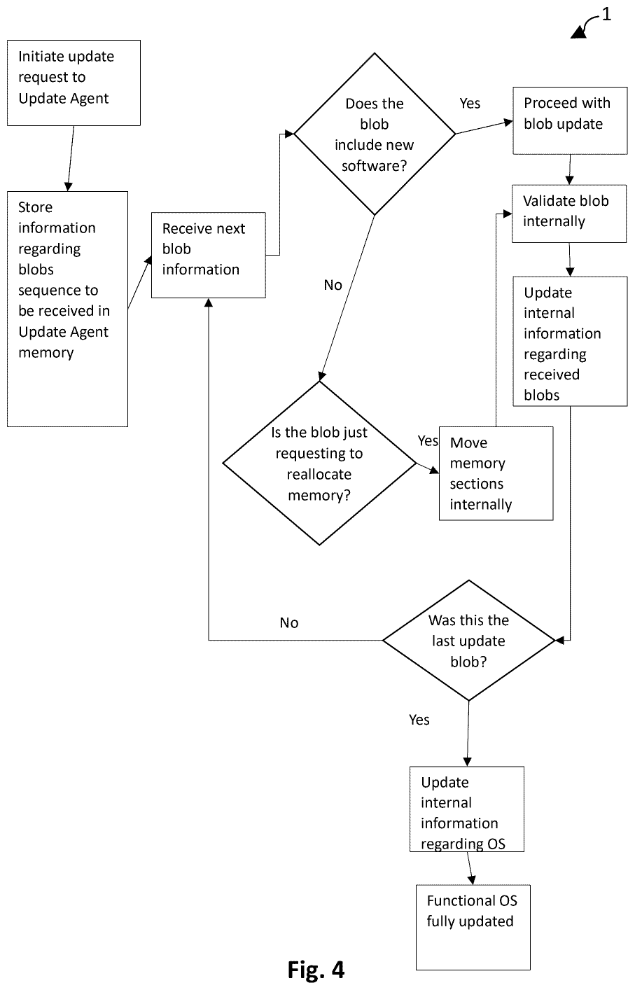

FIG. 4 shows schematic steps of a method for updating the secure element 6 by means of the installation program dataset I and/or system patching dataset J. Using the installation program dataset I and/or system patching dataset J as an ITL or a similar update agent solution, a full OS Update can be performed in different steps or blocks, allowing for rollback to be possible during the update at any time, for example, if connection is lost. In solution schemes for operating system update according to the prior art, the update needs to be fully performed, otherwise, the card will be left into a controlled state, managed by the loader itself instead of the Operative System, which means that all the functionalities provided by the OS will not be available. The software that is going to be updated is first erased and then the new one is loaded.

According to the proposed scheme, an operating system update is performed in small, independent blobs, which can be provided in the form of an update data subset F each, until the final OS, i.e., following version B and/or later version Y of the operating system dataset O, executable data subsets E asset or any part thereof is reached. All necessary intermediate states can be controlled and fully functional, in case the update was interrupted. This allows also different ways to perform the update, like internally moving memory instead of updating it from the off-card entity in order to allocate the changed memory regions. This proposal would also ensure rollback into the last stable intermediate state during the update, in case something went wrong with the full process.

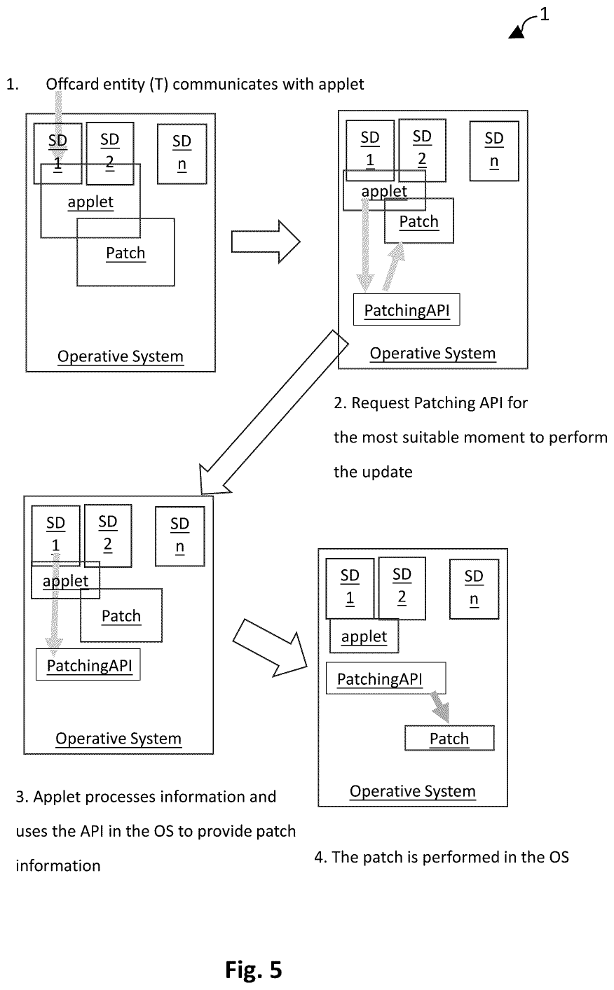

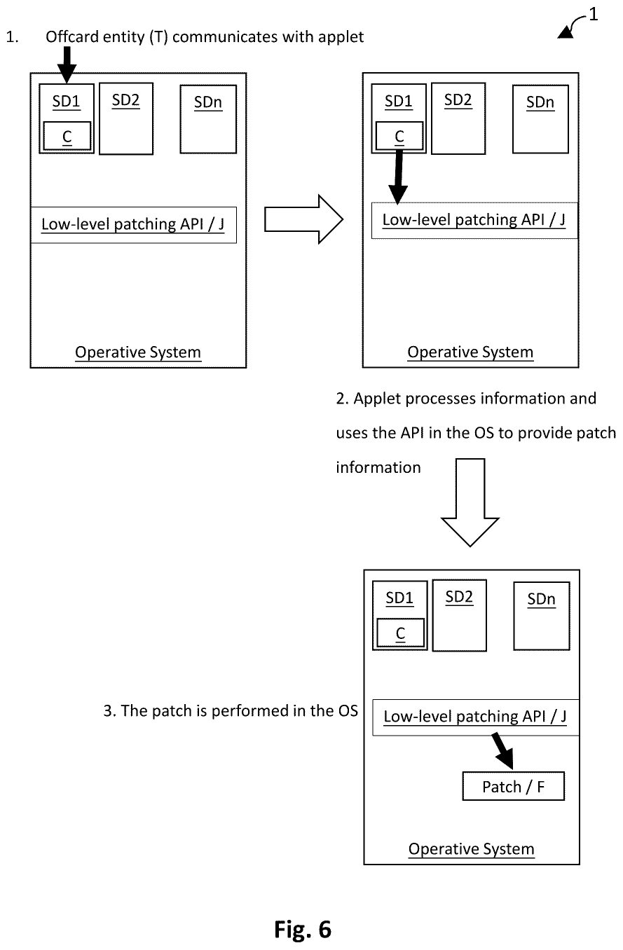

FIG. 5 is a schematic illustration of how an off-card entity, e.g., a trusted entity T not comprised in the secure element 6, can communicate with an application process C, such as an applet, running on the secure element 6. For example, a mechanism in the secure element 6 can be added to enable the update of small patches of software that can be provided in the form of update data subsets F through an applet in a Security Domain (SD) managed by a secure entity T. To do so, API to manage low-level patch management would be added into the software. Since the OS can be in use when the patch is requested, a deferred solution is proposed. In the context of Java Card technology or smart cards, a Security Domain manages access rights to certain functions and data on the card. Irrespective application would allow, via a specific low-level writing API in the operating system data set O, the provisioning and management of small software patches to provide low-footprint, fast patching in the field. Secure measures would be added to ensure that only the owner of the operating system dataset would be able to perform such updates.

A respective extra step/functionality can be added in the proposed configuration system 1 to ensure that the patch update does not happen while there are some ongoing processes in the operating system dataset O. Therefore, the applet, besides being able to manage the patching request, would be the one ensuring which is the best moment to proceed with it. Once the update data subset F asset or respective patch information is available, it would be stored by the application process C, for example, the form of an applet, until it decided to properly apply it. To do so, several checks would be performed through an API communicating with the operating system dataset O.

FIG. 5 is a schematic illustration of how an off-card entity, e.g., a trusted entity T not comprised in the secure element 6, can communicate with an application process C, such as an applet, running on the secure element 6. A respective mechanism in the secure element 6 can be provided to enable the update of small patches of software, e.g., In the form of respective update data subsets F through an application process C, such as an applet, in a Security Domain D managed by a secure entity T. To do so, API to manage low-level patch management can be added to the system patching dataset J. In the context of Java Card technology or smart cards, a Security Domain manages access rights to certain functions and data on the card.

According to the present example is to install an applet is installed into a dedicated Security Domain SD owned or managed by the same owner of the operating system dataset O (or a defined secured entity) in the secure element 6. This application would allow, via a specific low-level writing API in the OS, the provisioning and management of small software patches to provide low-footprint, fast patching in the field. Secure measures would be added to ensure that only the owner of the operating system dataset O would be able to perform such updates. The format of the patching and/or of a respective update data subset F would be a list of writing operations to do on the operating system dataset O (including, of course, both the addresses in which the writings need to be done and the content of such writing operations themselves).

According to the present exemplary embodiments, previous versions A, following versions B, former versions X, and/or later versions Y may relate to any version or part, executable data subset E and/or update data subset F of the application process C, the installation program dataset I, the system patching dataset J, the operating system dataset O, and/or any data object D configured as a part thereof and/or accessible thereby. The application process C, for example, provided in the form an application program dataset, such as an applet, providing the API, can be configured to interact with and/or the provided as a part of the installation program dataset I and/or the system patching dataset J. The operating system dataset O may be provided with and/or comprise the application process C, the installation program dataset I and/or the system patching dataset J. Communication between the server device 3 and the application process C can at least partially carried out using a secure channel protocol.

For example, the secure channel protocol may comprise any kind of protocol defined by a standardization body, such as SCP.03, SCP.04, SCP.80, SCP.81, etc., defined by GlobalPlatform. Further mechanisms of communication with the secure element 6 or any data set or subset, including the application process C, can be used, for example, in the form of application protocols, such as CoAP, and/or any other interfaces as defined in a customized way and/or or by standardization bodies, for example, the GSMA. Using CoAP may be particularly helpful for communicating with secure elements 6 having constrained memory and/or processing capabilities, also known as so-called constrained cards.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing one or more exemplary embodiments. It will be understood that various changes may be made in the function and arrangement of elements described in an exemplary embodiment without departing from the scope of the claims.

Additionally, it is noted that “comprising” or “including” does not exclude any other elements or steps and “a” or “an” does not exclude a multitude or plurality. It is further noted that features or steps which are described with reference to one of the above exemplary embodiments may also be used in combination with other features or steps of other exemplary embodiments described above. Reference signs in the claims are not to be construed as a limitation.

### REFERENCE SIGNS

1 configuration system
2 computing device
3 server device
4 hardware security module
5 user device
6 secure element
7 secure storage location
7a first memory region
7b second memory region
8 remote management application
9 communication interface
10 configuration program
11 computer-readable data carrier
12 computer-readable medium
13 data carrier signal
A previous version
B following version
C application process
C′ additional application process
D data object
E executable data subset
F update data subset
G notification signal
H security credentials
I installation program dataset
J system patching dataset
K application command
L diversified data
M predefined data format
N required data format
O operating system dataset
OTC one-time code
P user profile
Q supervision instance
R data update instance
S step
SD secure domain
T trusted entity
U user
V operating instance
W pre-issuance condition/state
X former version
Y later version
Z post-issuance condition/state
S0 initialize installation program
S1 provide data
S2 activate application process
S3 provide data object
S4 notification update/patch available
S5 notification requesting update/patch
S6 provide update data/patch
S7 perform update/patch
S8 finish update/patch
S9 assess update/patch success
S10 check data formats

What is claimed:

1. A method of configuring a secure element for secure operation involving a trusted entity, the method comprising the steps of
providing a secure element for a user device, with an operating system dataset for operating the secure element, the operating system dataset comprising a previous version of at least one executable data subset;
installing an application process on the operating system dataset providing access to an application program interface;
sending an update data subset through the application program interface to the secure element comprising at least a part of a following version of the at least one executable data subset defining a later version of the operating system dataset; and
providing a system patching dataset for managing an installation of the update data subset when implementing the at least a part of the following version of the at least one executable data subset on the secure element such that the later version of the operating system dataset can at least partly be executed.

2. The method according to claim 1, wherein the previous version of the at least one executable data subset is configured to access at least one data object having a predefined data format, and wherein at least when the later version can be executed, the system patching dataset checks whether the predefined data format of the at least one data object matches a required data format defined by the later version before accessing the at least one data object with the later version.

3. The method according to claim 2, further comprising the step of updating a predefined data format to the required data format if the predefined data format does not match the required data format.

4. The method according to claim 2, wherein the at least one data object is allocated to a certain memory region and the method further comprises the step of reallocating the at least one data object to a different memory region if the predefined data format does not match the required data format.

5. The method according to claim 1, wherein the system patching dataset is configured to patch the operating system dataset with the update data subset.

6. The method according to claim 1, wherein the system patching dataset is configured to jump to specific parts or sections of the operating system dataset addressed by the update data subset.

7. The method according to claim 1, wherein the system patching dataset is at least in part provided as a one-time code configured to be discarded after a successful installation process.

8. The method according to claim 1, wherein the system patching dataset enables implementation of at least two update steps configured as roll back options for the installation process.

9. The method according to claim 1, wherein the system patching dataset is configured to be executed in a security domain managed by a secure entity.

10. The method according to claim 1, wherein the system patching dataset is configured to defer or at least delay the installation process after receiving the update data subset.

11. A configuration program for configuring a secure element, in particular for secure operation involving a trusted entity, wherein the configuration program comprises instructions which, when the configuration program is executed by at least one of a server device, a user device and a secure element, cause at least one of a server device, a user device, and a secure element to carry out the steps of
providing a secure element for a user device, with an operating system dataset for operating the secure element, the operating system dataset comprising a previous version of at least one executable data subset;
installing an application process on the operating system dataset providing access to an application program interface;
sending an update data subset through the application program interface to the secure element comprising at least a part of a following version of the at least one executable data subset defining a later version of the operating system dataset; and
providing a system patching dataset for managing an installation of the update data subset when implementing the following version of the at least one executable data subset on the secure element such that the later version of the operating system dataset can be executed.

12. The configuration program according to claim 11 comprising the or comprised of the system patching dataset for updating at least a part of an operating system dataset of a secure element of a user device, wherein the secure element is an eUICC.

13. A secure element for a user device, in particular configured for allowing secure operation involving a trusted entity, with an operating system dataset for operating the secure element, the operating system dataset comprising a previous version of at least one executable data subset;
with an application process installed on the operating system dataset providing access to an application program interface;
wherein the secure element is configured to
receive an update data subset through the application program interface comprising at least a part of a following version of the at least one executable data subset defining a later version of the operating system dataset; and
use a system patching dataset for managing an installation of the update data subset when implementing the following version of the at least one executable data subset on the secure element such that the later version of the operating system dataset can be executed.

14. The secure element according to claim 13, wherein the previous version of the at least one executable data subset is configured to access at least one data object having a predefined data format, and wherein the at least one data object is allocated to a certain memory region and the method further comprises the step of reallocating the at least one data object to a different memory region if the predefined data format does not match the required data format.

15. The secure element according to claim 13, wherein the system patching dataset is configured to patch the operating system dataset with the update data subset.

16. The secure element according to claim 13, wherein the system patching dataset is configured to jump to specific parts or sections of the operating system dataset addressed by the update data subset.

17. The secure element according to claim 13, wherein the system patching dataset is at least in part provided as a one-time code configured to be discarded after a successful installation process.

18. The secure element according to claim 13, wherein the system patching dataset enables implementation of at least two update steps configured as roll back options for the installation process.

19. The secure element according to claim 13, wherein the system patching dataset is configured to be executed in a security domain managed by a secure entity.

20. The secure element according to claim 13, wherein the system patching dataset is configured to defer or at least delay the installation process after receiving the update data subset.
